(19) United States
(12) Patent Application Publication
(10) Pub. No.: US 2022/0373651 A1
(43) Pub. Date: Nov. 24, 2022

(54) LIDAR DETECTION DEVICE PROVIDED WITH A LAMINATED PROTECTIVE LAYER

(71) Applicant: AGC GLASS EUROPE, Louvain-la-Neuve (BE)

(72) Inventors: Marek NOVOTNY, Namur (BE); Philippe HOCKS, Gosselies (BE); Fabien DESCAMPS, Gosselies (BE); Yannick SARTENAER, Vedrin (BE)

(73) Assignee: AGC GLASS EUROPE, Louvain-la-Neuve (BE)

(21) Appl. No.: 17/767,356

(22) PCT Filed: Oct. 12, 2020
(86) PCT No.: PCT/EP2020/078638

§ 371 Date: Apr. 7, 2022

(30) Foreign Application Priority Data
Oct. 11, 2019 (EP) 19202813.2

(51) Int. Cl. G01S 7/481; B32B 17/10; B32B 27/30; B32B 27/40; B32B 27/36; B32B 27/32; B32B 25/20; B32B 27/20; B60Q 1/00; B60R 19/48

(52) U.S. Cl. CPC G01S 7/4813; B32B 17/10761; B32B 27/30; B32B 27/40; B32B 27/365; B32B 27/36; B32B 27/306; B32B 27/325; B32B 25/20; B32B 27/20; B32B 17/10036; B32B 17/10651; B32B 17/10119; B32B 17/10275; B60Q 1/0023; B60R 19/483; B32B 2255/00; B32B 2307/4023; B32B 2307/412; B32B 2605/00

(57) ABSTRACT

A detection device includes a Light Detection and Ranging (LiDAR) device enclosed in housing with a glass cover that has a mean transmittance at the LiDAR operating wavelength of at least 80%, to an IR-radiation in the wavelength range from 750 to 1650 nm. The glass cover is laminated and includes at least one glass sheet laminated with at least one thermoplastic interlayer. The thermoplastic interlayer has a mean transmittance at the LiDAR operating wavelength of at least 80%, to an IR-radiation in the wavelength range from 750 to 1650 nm, and has a light transmission in the visible range of less than 10% of the incident light.

### TECHNICAL FIELD

The present invention is in the field of detection devices suitable for use in automotive vehicles to assist a driver (ADAS=Advanced Driver Assistance System), including autonomous or self-driving vehicles. More particularly, the present invention concerns a LiDAR system composed of a housing and a solid-state LiDAR device lodged in the housing, having an increased service time and better aesthetic. The present invention concerns a laminated glass cover of the housing. When the LiDAR has to be placed around the car and more particularly behind a trim element or behind an automotive window, the visible part of the Lidar has to be aesthetic and more particularly the glass cover of the housing should be as discreet as possible while ensuring a good efficiency in term of transmittance to infra-red (IR).

### BACKGROUND OF THE INVENTION

Automotive vehicles are being equipped by more and more systems for assisting a driver of a vehicle. These are collectively referred to as ADAS (=Advanced Driver Assistance System). ADAS comprises detection systems able to detect and, in some cases, identify an obstacle in the immediate surrounding of the vehicle. For example, detection systems include optical or IR-cameras, radars, and LiDARs (=light detection and ranging). A LiDAR measures the distance between itself and objects in its field of view by calculating the time taken by a pulse of light to travel at the light speed to an object and back to the LiDAR. It comprises a light emitter, usually a laser source, and a light receiver. As a pulse of light emitted by the light emitter of a LiDAR hits an object of irregular shape, the incident light signal gets scattered and only a fraction of the light returns to the light receiver. US20150029487 describes an automotive vehicle equipped with a LiDAR-type device.

Mechanical scanning LiDARs constitute a first generation of LiDARs, using a powerful collimated laser source and concentrating the return signal on the receiver through highly focused optics. By rotating the laser and receiver assembly, the mechanical scanning LiDAR can scan the area around it and collect data over a wide area of up to 360 degrees. Mechanical scanning LiDARs are, however, generally bulky, delicate and very expensive. Solid-state LiDARs are a second generation of LiDARs that do not have the drawbacks of mechanical scanning LiDARs.

When mechanical scanning LiDARs rely on an electromechanical construction for scanning a single laser source over an area around it, solid-state LiDARs comprise no moving parts. Solid state LiDARs use an optical phased array wherein optical emitters send out bursts of photons in specific patterns and phases to create directional emission, of which the focus and size can be adjusted. An optical phased array is a row of emitters (e.g., laser) that can change the direction of an electromagnetic beam by adjusting the relative phase of the signal from one emitter to the next. A solid-state LiDAR is built on an electronic chip and is therefore much cheaper and resistant to vibrations than a mechanical scanning LiDAR. One drawback of solid-state LiDARs compared with a mechanical scanning LiDAR comprising a single laser source is that for a same energy consumption, the intensity of light emitted by an optical phased array is divided by the number of optical emitters. Optical phenomena like reflection, absorption, and scattering of light can become more problematic than with a single source of laser.

Solid-state LiDARs are being implemented more and more in automotive vehicles. They can be mounted on an exterior of an automotive vehicle which is a very aggressive environment exposed to rain, hail, large temperature variations, and impacts with various objects including gravel. To protect LiDARs from such environment, LiDAR devices are enclosed in a housing comprising a glass cover which is transparent to the wavelength used by the LiDAR. LiDARs can use, visible, or IR-light. LiDARs used in the automotive industry, however, generally emit light in the near infrared spectrum comprised between 750 and 1650 nm. The glass cover according to the present invention is made of at least one glass sheet having a mean transmittance at the LiDAR operating wavelength of at least 80%, preferably of at least 90% to an IR-radiation in the wavelength range from 750 to 1650 nm, preferably in the range of 750 to 1050 nm, more preferably in the range of 750 to 950 nm. Examples of glass covers suitable for use with LiDAR detection devices are described in US20150029487 and in EP20170185156 and the patent application PCT/EP2018/070954.

Such glass must of course maintain a high transmittance to the light emitted by the light sources.

Still further, the glass cover may be a prominent feature of an overall design such that the glass cover must be able to aesthetically blend with the overall design.

Today, it is known to provide a glass cover for a sensing device and more particularly for a LiDAR, to apply a paint or an enamel on at least one face of the glass cover to achieve the required aesthetic. In the case of a laminated cover glass wherein the interlayer is laminated between two glass sheets, the paint or the enamel is applied on the inner face, also commonly called P2 of the first glass sheet and/or the inner face, also called P3 of the second glass sheet.

However, the paint, or ink or the enamel diffuses, into the thermoplastic interlayer during the manufacturing process of the laminated cover glass leading to an non-aesthetic aspect of the cover glass and therefore cannot be used efficiently as a cover for the sensing device.

Furthermore, the diffusion of the paint or ink or enamel into the thermoplastic interlayer increases the haze of the glass cover. Thus, the image captured by the sensor device may be blurred which can be very damaging the function of the sensor device and more particularly to the LiDAR.

Also, when the paint, the ink or the enamel has to be applied on the surface of the inner face of the glass sheet in contact with the thermoplastic interlayer, the paint, the ink or the enamel has to undergo a complete curing leading sometimes to a poor adhesion of the thermoplastic interlayer to the glass sheet with a risk of delamination. Then, the mechanical and the time life of glass cover are negatively impacted.

For this reason, there is a need to propose a laminated cover with anaesthetic aspect and answering the requirement of a glass cover for a LiDAR device.

With the evolution of the ADAS and of the autonomous vehicles requiring a multitude of detection systems, it is not acceptable to have a glass cover with an unaesthetic aspect and that may alter the efficiency of the LiDAR system.

The present invention proposes a solution to this problem allowing an efficient, resistant, and aesthetic LiDAR system at low cost compared with the present systems. These and other advantages are described in more details in the following sections.

### SUMMARY OF THE INVENTION

The present invention is defined in the appended independent claims. Preferred embodiments are defined in the dependent claims. In particular, the present invention concerns a detection device comprising,
(a) a Light Detection and Ranging (LiDAR) device, enclosed in
(b) a housing provided with a laminated glass cover fixed to the housing, the laminated glass cover of the housing having a mean transmittance at the LiDAR operating wavelength of at least 80%, preferably of at least 90% to an IR-radiation in the wavelength range from 750 to 1650 nm .

According to the present invention, the laminated glass cover comprises at least one glass sheet laminated with at least one thermoplastic interlayer, the thermoplastic interlayer having a mean transmittance at the LiDAR operating wavelength of at least 80%, preferably of at least 90% to an IR-radiation in the wavelength range from 750 to 1650 nm, and having a light transmission in the visible range (380-780 nm), less than 10% of the incident light and preferably less than 5% of the incident light and more preferably less than 2% of the incident light and very more preferably equal to 0% of the incident light.

According to the present invention, it is understood that the light transmission is calculated according to ISO 9050 standard as LT D65 10°.

According to the present invention, the laminated glass cover has a mean transmittance at the LiDAR operating wavelength of at least 80%, preferably of at least 90% to an IR-radiation in the wavelength range from 750 to 1650 nm, preferably in the range of 750 to 1050 nm, more preferably in the range of 750 to 950 nm.

According to the present invention, the thermoplastic interlayer has a mean transmittance at the LiDAR operating wavelength of at least 80%, preferably of at least 90% to an IR-radiation in the wavelength range from 750 to 1650 nm, preferably in the range of 750 to 1050 nm, more preferably in the range of 750 to 950 nm and has a light transmission in the visible range (380-780 nm) less than 10% of the incident light and preferably less than 5% of the incident light and more preferably less than 2% of the incident light and very more preferably equal to 0% of the incident light.

The thermoplastic interlayer according to the present invention, confers to the laminated glass cover a resistance to multiple impacts by stone-chips while aesthetic and efficiency of the Lidar system are maintained, even improved.

According to an embodiment of the present invention, the thermoplastic interlayer is a black thermoplastic interlayer having a light transmission in the visible range (380-780 nm), less than 10% of the incident light and preferably less than 5% of the incident light and more preferably less than 2% of the incident light and very more preferably equal to 0% of the incident light.

According to the present invention, by using a thermoplastic interlayer as described above instead of using a paint, an ink or an enamel on the surface of the at least one glass sheet forming the laminated glass cover allows to use a curved glass sheet. Indeed, if a paint, ink or enamel should be applied on the surface of the glass sheet, the glass sheet cannot be thermally bent without deteriorating the paint, ink or the enamel.

By using a thermoplastic interlayer according to the present invention, there is more flexibility to curve/bend and to deposit a coating, for example an anti-reflecting coating directly on at least one surface of the glass sheet forming the laminated glass cover.

Thus, thanks to the present invention, the laminated glass cover may be flat or curved.

A curved laminated glass cover allows to improve the efficiency of the LiDAR without having a negative impact of light reflection, which is the case of flat LiDAR covers. Indeed, the scanning angle of the LiDAR is enlarged. Furthermore, one of the advantages of using a curved glass cover is that it gives more flexibility in term of design to LiDAR and/or vehicle (car, trucks, plane . . . ) manufacturers.

In a preferred embodiment, the laminated glass cover may comprise an antireflection layer or a coating to further enhance the transmission at interested wavelengths. The AR coating may, for example, be a layer based on porous silica having a low refractive index or it may be composed of several layers (stack), in particular a stack of layers of dielectric material alternating layers having low and high refractive indexes and terminating in a layer having a low refractive index. The AR coating may, for example, be a layer based on refractive index gradient layer deposited for example by ion implantation technique. A textured surface may be also used. Etching or coating techniques may as well be used in order to avoid reflection. Preferably, the reflection of the treated surface would decrease from at least 1% within the concerned wavelength range.

Unless defined otherwise, when the expression “IR-radiation” is used, it refers to a radiation of wavelength comprised between 750 to 1650 nm.

In one embodiment, the laminated glass cover comprises a first glass sheet and a second glass sheet laminated together via the thermoplastic interlayer according to the present invention.

In another embodiment, the laminated glass cover may comprise a first glass sheet, a thermoplastic interlayer according to the present invention and a transparent sheet suitable to be used in combination with the first glass sheet and answering the requirement regarding the efficiency of the LiDAR. The transparent sheet may be for example a polycarbonate sheet, a polyethylene terephthalate (PET) film coated with a well-known anti-scratch coating. It is understood that any suitable material may be used in combination with the at least one glass sheet and the thermoplastic interlayer according to the present invention.

According to an embodiment of the present invention, the laminated glass cover comprises at least one soda lime glass sheet.

According to an embodiment of the present invention, the laminated glass cover is made of soda lime glass, borosilicate glass, aluminosilicate glass, glass-ceramic or quartz glass or any suitable type of glass suitable to be used as glass cover for LiDAR according to the present invention.

According to one embodiment of the present invention, the thermoplastic interlayer has a light transmission equal to 0% of the incident light.

According to another embodiment of the present invention, the thermoplastic interlayer is a bulk-dyed interlayer with an infra-red (IR)-transparent ink also called IR non absorbing ink.

According to a preferred embodiment, the thermoplastic interlayer according to the present invention is a black interlayer having a mean transmittance at the LiDAR operating wavelength of at least 80%, preferably of at least 90% to an IR-radiation in the wavelength range from 750 to 1650 nm and having a light transmission in visible light less than 2% of the incident light and preferably equal to 0% of the incident light.

According to an embodiment of the present invention, the thermoplastic interlayer is dyed with an IR-transparent ink having a mean transmittance at the LiDAR operating wavelength of at least 80%, preferably of at least 90% to an IR-radiation in the wavelength range from 750 to 1650 nm and having a light transmission in the visible range (380-780 nm), less than 10% of the incident light and preferably less than 5% of the incident light and more preferably less than 2% of the incident light and very more preferably equal to 0% of the incident light.

An IR-transparent ink has the special characteristics which allow IR (Infrared ray) to pass through the ink, but it will block the visible light and optionally ultra violet ray (Sun light and etc.). As for the designated wavelength, transmittance rate can be adjusted by different formation of printed ink layer on the thermoplastic interlayer.

According to one embodiment, the IR-transparent ink is a pigment-based IR transparent ink or a dye-based IR transparent ink. A pigment-based ink typically comprises solid particles of pigment powder suspended in the ink while a dye-based ink typically comprises a dye that is dissolved in the ink. The binder or resin of the IR-transparent ink may be any type of polymer such as epoxy, acrylate, polyester, polyurethane, or any mixture of these. The binder or resin of the IR transparent ink may be of any type known to the skilled person. Some non-exhaustive examples of suitable binders are polymers such as epoxy polymers, acrylic polymers, vinylic polymers, polyurethanes, polyesters or any mixture of these. The binder may also for instance be based on vegetal oils or on UV (ultraviolet) or EB (electron beam) curable components. Such inks are commercially available for example from Teikoku, Proell, Toray, Nazdar, Epolin companies.

Preferably, the IR-transparent is a black ink. The surface of the IR-transparent ink shows neutral deep black for aesthetical reasons.

According to the present invention, the thermoplastic interlayer can be a polymer sheet comprising polyvinyl butyral (PVB), polyurethane (PU), polycarbonate (PC), polyester, copolymers, ethylene-vinyl acetate (EVA), cyclo-olefin polymer (COP), silicone, polyolefins (PE, PP, . . . ) or blends thereof.

According to a preferred embodiment of the present invention, the laminated glass cover is made of two glass sheets laminated together with a thermoplastic interlayer as described above.

The LiDAR device is preferably mounted on an automotive vehicle. For example, the LiDAR can be integrated on/in a fender, a bumper, a grill, a wing mirror cover, a rear-view mirror cover, a bonnet, a side door, a pillar (A, B, C, D), or door or roof.

In another example, the detection device may be placed behind a trim element as described in the patent on application EP3487825.

In another example, the glass cover can be a part of a transparent component of an automotive vehicle, including a windscreen, a rear window, a lateral window, a headlight or tail light cover. It is understood that when the LiDAR comprising the laminated glass cover according to the invention, is a part of a windscreen or more generally a window, the LiDAR is placed in a zone outside the field of view. The LiDAR should not be placed in a zone wherein a light transmission in the visible range more than 10% of the incident light is needed.

The present invention also concerns the use of a laminated glass cover fixed to a housing enclosing a solid-state LiDAR.

The present invention also concerns a method for manufacturing a laminated glass cover to be fixed to a housing comprising a LiDAR, said method comprising the following steps,
(a) Providing at least one glass sheet having a mean transmittance at the LiDAR operating wavelength of at least 80%, preferably of at least 90% to an IR-radiation in the wavelength range from 750 to 1650 nm, preferably in the range of 750 to 1050 nm, more preferably in the range of 750 to 950 nm,
(b) Laminating the at least one glass sheet with a thermoplastic interlayer having a mean transmittance at the LiDAR operating wavelength of at least 80%, preferably of at least 90% to an IR-radiation in the wavelength range from 750 to 1650 nm, preferably in the range of 750 to 1050 nm, more preferably in the range of 750 to 950 nm, and having a light transmission in the visible range (380-780 nm), less than 10% of the incident light and preferably less than 5% of the incident light and more preferably less than 2% of the incident light and very more preferably equal to 0% of the incident light.

According to one embodiment of the present invention, the method for manufacturing a laminated glass cover to be fixed to a housing comprising a LiDAR, said method comprising the following steps,
(a) Providing at least one glass sheet having a mean transmittance at the LiDAR operating wavelength of at least 80%, preferably of at least 90% to an IR-radiation in the wavelength range from 750 to 1650 nm, preferably in the range of 750 to 1050 nm, more preferably in the range of 750 to 950 nm,
(b) Placing on the at least one glass sheet a thermoplastic interlayer having a mean transmittance at the LiDAR operating wavelength of at least 80%, preferably of at least 90% to an IR-radiation in the wavelength range from 750 to 1650 nm, preferably in the range of 750 to 1050 nm, more preferably in the range of 750 to 950 nm, and having a light transmission in the visible range (380-780 nm), less than 10% of the incident light and preferably less than 5% of the incident light and more preferably less than 2% of the incident light and very more preferably equal to 0% of the incident light,
(c) Placing a second glass sheet having a mean transmittance at the LiDAR operating wavelength of at least 80%, preferably of at least 90% to an IR-radiation in the wavelength range from 750 to 1650 nm, preferably in the range of 750 to 1050 nm, more preferably in the range of 750 to 950 nm, the interlayer being sandwiched between the two glass sheets forming a laminated glass cover.

The thermoplastic interlayer having interlayer having a mean transmittance at the LiDAR operating wavelength of at least 80%, preferably of at least 90% to an IR-radiation in the wavelength range from 750 to 1650 nm, preferably in the range of 750 to 1050 nm, more preferably in the range of 750 to 950 nm, and having light transmission in the visible range (380-780 nm), less than 10% of the incident light and preferably less than 5% of the incident light and more preferably less than 2% of the incident light and very more preferably equal to 0% of the incident light allows to:
reinforce the glass cover to be fixed to a housing comprising a LiDAR and comply the safety standard and regulations,
better protect the LiDAR comprised in the housing,
give a good aesthetic by masking at least partly the LiDAR while ensuring a good efficiency of the LiDAR.

The present invention also concerns an automotive vehicle comprising a detection device as defined supra, wherein the vehicle is preferably a self-driving vehicle.

### BRIEF DESCRIPTION OF THE FIGURES

For a fuller understanding of the nature of the present invention, reference is made to the following detailed description taken in conjunction with the accompanying drawings in which:

FIG. 1: shows an exploded view of a detection device according to the present invention.

FIG. 2: shows an automotive vehicle with various locations where a detection device according to the present invention can be located.

### DETAILED DESCRIPTION OF THE INVENTION

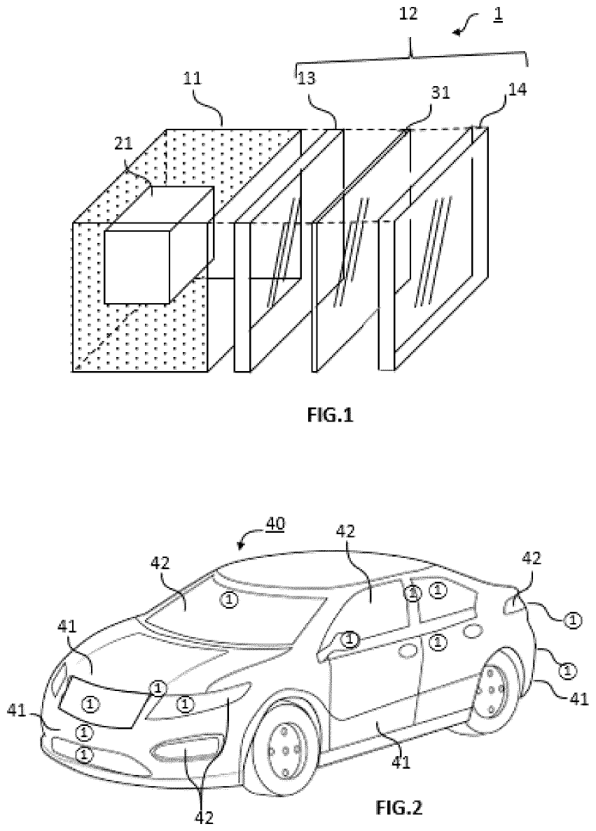

As illustrated in FIG. 1, the present invention concerns a LiDAR device comprising a solid-state LiDAR device (21) enclosed in a housing (11) provided with a glass cover (12) made of a first glass sheet (13), a thermoplastic interlayer (31) and a second glass sheet (14). According to the present invention , the first (13) and the second (14) glass sheet having a mean transmittance at the LiDAR operating wavelength of at least 80%, preferably of at least 90% to an IR-radiation in the wavelength range from 750 to 1650 nm, preferably in the range of 750 to 1050 nm, more preferably in the range of 750 to 950 nm. The thermoplastic interlayer has having a mean transmittance at the LiDAR operating wavelength of at least 80%, preferably of at least 90% to an IR-radiation in the wavelength range from 750 to 1650 nm, preferably in the range of 750 to 1050 nm, more preferably in the range of 750 to 950 nm, and having a light transmission in the visible range (380-780 nm), less than 10% of the incident light and preferably less than 5% of the incident light and more preferably less than 2% of the incident light and very more preferably equal to 0% of the incident light. Such thermoplastic interlayer is a PVB interlayer dyed in the bulk with a black IR-transparent ink such as provided by Teikoku, Toray or any known IR-transparent ink having a light transmission in the visible range (380-780 nm), less than 10% of the incident light and preferably less than 5% of the incident light and more preferably less than 2% of the incident light. The LiDAR must be enclosed in a housing to protect it from external aggressions, such as dirt and impacts from gravel or hail. The present invention proposes a solution for prolonging the service life of a LiDAR system, while ensuring the efficiency of the Lidar and giving a good aesthetic. The glass cover is then more resistant and the weak light transmission of the thermoplastic interlayer while being transparent to IR- radiation allow to provide a very efficient glass cover to be fixed to the housing enclosing the LiDAR with required optical properties.

As discussed above, solid-state LiDAR comprise a phase array of optical emitters (lasers) which create a beam of optical waves that can be electronically steered to point in different directions without moving the optical emitters. Each optical emitter is set with a phase relationship such that the optical waves from the separate emitters add together to increase the radiation in a desired direction, while cancelling to suppress radiation in undesired directions. In a phased array, a beam of optical waves can be steered to a different direction by controlling the phase shift between emitters.

To protect the solid state LiDAR from external aggressions, it is enclosed in a housing comprising a glass cover to allow the passage of emitted radiations as well as of returned radiation bounced back on an obstacle.

### Glass cover (12)

The emitted radiations must traverse the glass cover (12) of the housing (11) until they hit an obstacle and part of the radiations are reflected back to the detection device, where they must traverse the glass cover (12) again before reaching an optical sensor. The glass cover (12) to be traversed by the incident beam and a return beam reflected off an obstacle must have a high transmittance to infrared light, commonly used in LiDARs mounted on automotive vehicles(40).

It is essential for the good functioning of the LiDAR detection device (1) that the glass cover (12) has, on the one hand, a high transmittance, to the wavelengths emitted by the LiDAR, which are generally comprised within the IR-range, preferably between 750 to 1650 nm. It is important for the service life of the LiDAR detection device that these values be maintained during use of a vehicle, exposing the glass cover (12) to external aggressions including rain, frost, and impacts from hail and gravels.

For reducing absorption of IR-radiations, the glass sheet should be as thin as possible. It is preferred that the glass sheet have a thickness of not more than 2 mm, preferably not more than 1 mm. The glass sheet preferably has a weak while keeping its robustness.

The glass sheet can be a soda lime glass sheet. An example of soda lime glass composition comprises the following components:

| | |
|---|---|
| SiO₂ | 55-85% |
| Al₂O₃ | 0-30% |
| B₂O₃ | 0-20% |
| Na₂O | 0-25% |
| CaO | 0-20% |
| MgO | 0-15% |
| K₂O | 0-20% |
| BaO | 0-20% |
| Cr₂O₃ | 0.0001-0.06%. |
| Co | 0-1% |
| Total iron (expressed as Fe₂O₃) | 0.002-1% |

Such glass sheet has a very high transmittance to IR-radiations used by LiDARs detection devices in automotive vehicles. The glass cover (12) can also be made of glass. Preferably, the glass cover (12) is made of glass and has a composition within the ranges defined supra for the glass sheet.

According to one embodiment of the present invention, the glass cover can be a coated layer applied onto the outer surface of the glass cover (12) by any known technique such as, dip-coating, spraying, or sputtering. The coating must be removable with a solvent, other than water (because of rain), by a heat treatment which does not affect negatively the glass cover the coating is adhered to, or by mechanically scraping the coating.

The glass cover (12) can have a three-dimensional (3D-) geometry.

Because rain and frost can temporarily disrupt the optical properties of the assembly of a glass cover (12), the latter can comprise a hydrophobic outer surface, exposed to atmosphere when covering the glass cover (12). The hydrophobicity can be obtained either by the choice of a polymer sheet or coating having a low surface energy, or by applying a hydrophobic layer to the glass cover. A surface is considered as being hydrophobic when a water droplet laid on the surface forms a static water contact angle greater than 90°.

The optical properties of the thermoplastic interlayer according to the present invention does not hinder the good functioning of the LiDAR detection device based on transmission of light beams through a glass cover. The main objective of the laminated glass cover (12), however, is the protection of the optical sensor of the LiDAR. This can be achieved with the mechanical properties discussed below.

A detection device according to the present invention is particularly suitable for use in automotive vehicles, ships, airplanes, and the like. Preferably, a detection device according to the present invention is mounted on an automotive vehicle, more preferably on a self-driving automotive vehicle. Automotive vehicles include cars, vans, lorries, motor bikes, buses, trams, trains, and the like.

FIG. 2 shows a typical car and also shows examples of localizations of detection devices by the enclosed numeral (1). Detection devices can be mounted on/in body elements (41) including fenders, bumpers, grills, wing mirror covers, bonnet, boot, side doors, a pillar (A, B, C, D), or back doors. Detection devices can also be mounted behind transparent body elements (42) including front windscreen, rear window, lateral windows, headlight or tail light covers, and the like. It is understood that when the LiDAR comprising the laminated glass cover according to the invention, is a part of a windscreen or more generally a window, the LiDAR is placed in a zone outside the field of view. The LiDAR should not be placed in a zone wherein a light transmission in the visible range more than 10% of the incident light is needed.

| REF# | Feature |
|---|---|
| 1 | Detection device |
| 11 | Housing |
| 12 | Glass cover |
| 21 | Solid state LiDAR |
| 31 | thermoplastic layer |
| 40 | Automotive vehicle |
| 41 | Non-transparent body element |
| 42 | Transparent body element |

1. A detection device comprising,
a Light Detection and Ranging (LiDAR) device, enclosed in
housing provided with a glass cover having a mean transmittance at a LiDAR operating wavelength of at least 80%, to an IR-radiation in a wavelength range from 750 to 1650 nm,
wherein the glass cover is a laminated glass cover comprising at least one glass sheet laminated with at least one thermoplastic interlayer, the thermoplastic interlayer having a mean transmittance at the LiDAR operating wavelength of at least 80%, to an IR-radiation in the wavelength range from 750 to 1650 nm, and having a light transmission in a visible range, of less than 10% of incident light.

2. The detection device according to claim 1, wherein the glass cover and the at least one thermoplastic interlayer have the mean transmittance at the LiDAR operating wavelength of at least 80%, to the IR-radiation in the wavelength range from 750 to 1050 nm.

3. The detection device according to claim 1, wherein the least one thermoplastic interlayer has light transmission in the visible range of less than 5% of the incident light.

4. The detection device according to claim 1, wherein the thermoplastic interlayer has light transmission equal to 0% of the incident light.

5. The detection device according to claim 1, wherein the thermoplastic interlayer is a bulk-dyed interlayer with an IR-transparent ink.

6. The detection device according to claim 1, wherein the thermoplastic interlayer is a bulk-dyed interlayer with a black IR-transparent ink.

7. The detection device according to claim 1, wherein the glass cover is made of two glass sheets laminated with a black interlayer transparent to IR having the mean transmittance at the LiDAR operating wavelength of at least 80%, to the IR-radiation in the wavelength range from 750 to 1650 nm, and having light transmission in the visible range of less than 10% of the incident light.

8. The detection device according to claim 1, wherein the glass cover is selected from a group consisting of soda lime glass, borosilicate glass, aluminosilicate glass, glass-ceramic and quartz glass.

9. The detection device according to claim 1, wherein the thermoplastic interlayer is a polymer sheet selected from a group consisting of polyvinyl butyral, polyurethane, polycarbonate, polyester, copolymers, ethylene-vinyl acetate, cyclo-olefin polymer, silicone, and polyolefin.

10. The detection device according to claim 1, wherein the thermoplastic interlayer is a printed interlayer with an IR-transparent ink or dye.

11. The detection device according to claim 1, wherein the thermoplastic interlayer is a polyvinyl butyral interlayer batch-dyed or printed with a black IR-transparent ink.

12. The detection device according to claim 1, wherein the laminated glass cover is bent.

13. The detection device according to claim 1, wherein the glass cover is integrated on/in an exterior element of a vehicle selected from a group consisting of a fender, a bumper, a grill, a wing mirror cover, a side door, a pillar (A, B, C, D), a door, a roof of a vehicle, and a trim element.

14. The detection device according to claim 1, wherein the glass cover comprises a transparent part of an automotive vehicle, selected from a group consisting of a windscreen, a rear window, a lateral window, a headlight and a tail light cover.

15. An automotive vehicle comprising the detection device according to claim 1, wherein the automotive vehicle is a self-driving vehicle.

16. The detection device according to claim 1, wherein the thermoplastic interlayer has the mean transmittance at the LiDAR operating wavelength of at least 90% to the IR-radiation in the wavelength range from 750 to 1650 nm.

17. The detection device according to claim 2, wherein the thermoplastic interlayer has the mean transmittance at the LiDAR operating wavelength of at least 80% to the IR-radiation in the wavelength range from 750 to 950 nm.

18. The detection device according to claim 3, wherein the thermoplastic interlayer has light transmission in the visible range of less than 2% of the incident light.
